(19) United States
(12) Patent Application Publication
(10) Pub. No.: US 2007/0164609 A1
(43) Pub. Date: Jul. 19, 2007

(54) RECEIVER AND DISTRIBUTION UNIT FOR VEHICLE ENTERTAINMENT SYSTEM

(76) Inventors: David M. Shalam, Syosset, NY (US); James R. Tranchina, Dix Hills, NY (US)

Correspondence Address: Frank Chau, Esq.;F. CHAU & ASSOCIATES, LLC, 130 Woodbury Road, Woodbury, NY, 11797, US

(21) Appl. No.: 11/619,240

(22) Filed: Jan. 3, 2007

Related U.S. Application Data
(60) Provisional application No. 60/756,070, filed on Jan. 4, 2006.

(51) Int. Cl. B60L 1/00

(52) U.S. Cl. 307/10.1

(57) ABSTRACT

A receiver and distribution unit in a vehicle that includes a wireless receiver unit and a signal processor. The wireless receiver unit receives a first signal wirelessly from a cellular network. The signal processor decodes the first signal into a second signal for output to a display and a sound system. The second signal may include video signals for output to the display and audio signals for output to the sound system. The display may be an liquid crystal display and may be mounted in a headrest of a seat in the vehicle.

### CROSS-REFERENCE TO RELATED PATENT APPLICATION

This application claims the benefit of Provisional Application Ser. No. 60/756,070, filed on Jan. 4, 2006, the contents of which are herein incorporated by reference in their entirety.

### BACKGROUND OF THE INVENTION

1. Technical Field

The present disclosure relates to a receiver and distribution unit for a vehicle entertainment system.

2. Discussion of the Related Art

As society becomes more mobile and therefore spends a greater amount of time traveling and away from home, demand rises for electronic devices outside the home environment. For example, media units including video screens have been mounted in the headrests of vehicles, facilitating video and audio from different media sources located in different portions of the vehicle.

Conventional vehicle entertainment systems play the CDs, DVDs, and VHS tapes brought into the vehicle by passengers. However, such systems are limited in their ability to provide a dynamic selection if media choices. Various media are available over wireless cellular phone networks to cellular phones and personal digital assistants (PDAs).

Therefore, a need exists for a receiver and distribution unit for a vehicle entertainment system which can wirelessly receive media and distribute that media to users of the vehicle.

### SUMMARY OF THE INVENTION

A receiver and distribution unit in a vehicle, according to an exemplary embodiment of the present invention, comprises a wireless receiver unit receiving a first signal wirelessly from a cellular network, and signal processor decoding the first signal into a second signal for output to a display and sound. The second signal may include video signals for output to the display and audio signals for output to the sound system. The display may be a liquid crystal display and may be mounted in a headrest of a seat in the vehicle.

The receiver and distribution unit may further include a common data bus, and a bus controller for controlling access to the common data bus. The wireless receiver and the signal processor are connected to the common data bus via and bus controller.

A wireless media system for a vehicle, according to an exemplary embodiment of the present invention, comprises a receiver unit for receiving a current media signal wirelessly from a cellular network, a speaker, a display, and a signal processor for decoding the current media signal output by the wireless receiver into audio and video signals. The video signals are output to the display and the audio signals are output to the speaker.

A receiver and distribution unit for a vehicle, according to an exemplary embodiment of the present invention, comprises a receiver unit which wirelessly receives media signals, decodes the media signals to generate audio signals and video signals, and a docking station which transmits the audio signals to a sound system in the vehicle and the video signals to one or more displays in the vehicle. The docking station is mounted in the vehicle and the receiver unit is removably connected to the docking station.

The docking station may include a centralized power relay for providing power to the one or more displays. The receiver unit may receive power from the docking station. The one or more displays may be mounted in a headrest of the vehicle.

### BRIEF DESCRIPTION OF THE DRAWINGS

The above and other features of the present invention will become more readily apparent by describing in detail exemplary embodiments thereof with reference to the accompanying drawings, in which:

FIG. 1 is a block diagram showing a receiver and distribution unit, according to an embodiment of the present invention;

FIG. 2 is a schematic diagram showing connections the receiver and distribution unit in a vehicle, according to an embodiment of the present invention; and

FIGS. 3a, 3b, and 3c illustrate a receiver and distribution unit according to an exemplary embodiment of the present invention.

### DETAILED DESCRIPTION OF EXEMPLARY EMBODIMENTS

Exemplary embodiments of the present invention now will be described more fully hereinafter with reference to the accompanying drawings. This invention, may however, be embodied in many different forms and should not be construed as limited to the embodiments set forth herein.

Embodiments of the invention relate to a receiver and distribution unit for a vehicle entertainment system. For example, the entertainment system includes the receiver and distribution unit and at least one display screen mounted in a vehicle, such as an automobile, minivan or sport utility vehicle (SUV). The display screen is electrically connected to the receiver and distribution unit for receipt of multimedia content, such as, for example, video, audio and text. The receiver and distribution unit preferably receives the multimedia content via a wireless distribution network, such as a cellular network.

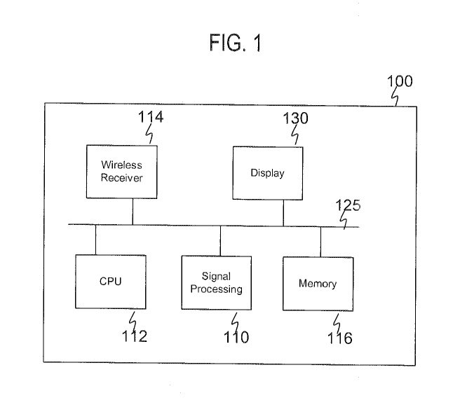

FIG. 1 is a block diagram showing a receiver and distribution unit, according to an embodiment of the present invention; and

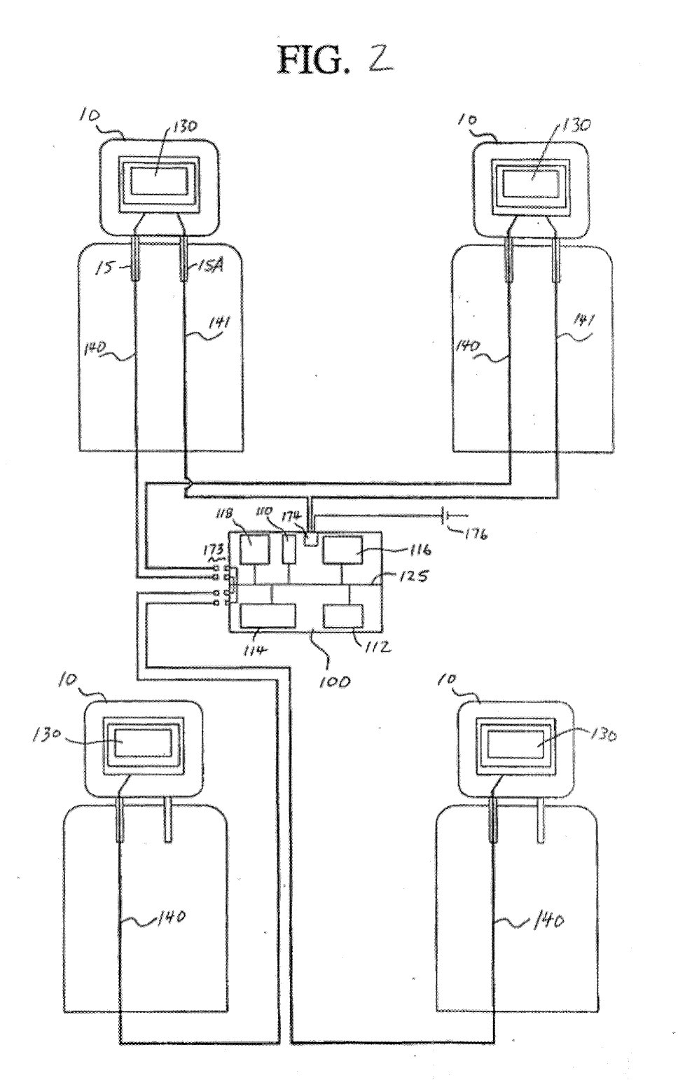

FIG. 2 is a schematic diagram showing connections to the receiver and distribution unit in a vehicle, according to an embodiment of the present invention.

Referring to FIG. 1, the receiver and distribution unit 100 includes a wireless receiver 114, which receives multimedia data, such as, for example, video, audio, metadata, and text in, for example, JPEG or MPEG formats. Formatting may include compression of the data using, for example, JPEG, MPEG, MPEG-2 and MPEG-4 procedures. Wireless capability may be provided by, for example, a wireless card, which fits into a standard PCMCIA (Personal computer Memory Card International Association) slot.

The data may be transmitted by any known wireless network, such as satellite, and is preferably transmitted via a cellular network. For example, the receiver and distribution unit 100 is similar in function to a cellular mobile device that is capable of receiving and storing multimedia content, such as, for example, a cellular telephone or personal digital assistant (PDA). In an embodiment, the receiver and distribution unit 100 receives multimedia content, including, for example, video programs, via a cellular system. A user of the receiver and distribution unit 100 may be a subscriber to such a system and receive multimedia data in accordance with the terms of the user's subscription. In different embodiments, a receiver and distribution unit 100 can receive and store data transmitted by systems such as the MediaFLO™ media distribution system offered by QUALCOMM, Inc., or systems offered by other cellular networks, such as VERIZON and CINGULAR.

The received multimedia data is stored in a memory portion 116 of the unit 100. The memory 116 can include, for example, a memory card that fits into a PCMCIA slot, a hard drive, a digital video recorder, or any other available storage device. The multimedia data stored in the memory 116 can be retrieved by a user at any time for playing, for example, on a display or through a stereo system of the vehicle. Selection of programming to be played can be made via remote, touch-screen or standard button controls that may correspond to a menu or channel selection guide appearing on a display.

The received data may require processing prior to being viewed or heard by a user. Accordingly, the unit 100 is equipped with components for performing signal processing and/or signal conversion 110 (hereinafter “signal processing/conversion facilities”). The signal processing/conversion facilities 110 include components, such as demodulators and decoders to reformat the transmitted audio and video data for display and listening. Such reformatting may include decompression of compressed audio and video data.

The signal processing/conversion facilities 110 may perform such processing/conversion prior to the signals being provided to the display device 130 or any other device (e.g., speakers). Alternatively, the display device 130 or stereo system can include such signal processing/conversion facilities.

The signal processing/conversion facilities 110 may include, but are not limited to, Digital Signal Processors (DSPs), and facilities for performing encoding/decoding, encrypting/decrypting, compressing/decompressing, analog-to-digital conversion (ADC), digital-to-analog conversion (DAC), and error correction. Such error correction may include, but is not limited to, Cyclic Redundancy Checking (CRC), Error Correction Code or Error Checking and Correcting (ECC), checksum, and so forth.

In many cases, the facilities described above may be implemented by one or more codecs. In other cases, additional and/or other circuitry may be required.

It is to be appreciated that the signal processing/conversion facilities 110 described above with respect to the console may be located separate from or as part of the wireless receiver 114. It is to be further appreciated that one of ordinary skill in the related art will contemplate these and various other facilities for performing signal processing and/or signal conversion, while maintaining the spirit and scope of the invention.

The unit also includes a central processing unit )CPU) 112. The processor 112 may be used to control and/or interact with any of the elements associated with the unit 100. The elements shown in FIG. 1 may be connected by one or more buses 125.

The display 130 includes a screen for displaying video. The screen is preferably an LCD type display, but may be another type of display, such as, for example, an organic LED or electro-luminescent display. The display 130 may include speakers for outputting audio. Alternatively, speakers may be separately provided as part of the unit 100, or an electrical connection can be made to speakers positioned remote from the unit. Similarly, the display 130 may be part of the unit 100 or positioned remote from the unit 100, as shown in FIG. 2.

The unit 100 may be positioned in any number of locations in a vehicle. For example, a unit 100 may be positioned overhead in a vehicle and can be coupled to a flip-down display 130. The unit 100 may also be mounted to a seat, positioned in a dashboard, under a seat, in a trunk or rear portion, or in a center console, or in any other convenient location of the vehicle.

Referring to FIG. 2 a headrest 10 includes a display 130 having a screen for displaying video. The display 130 is connected to the data bus 125 to receive the multimedia signals from the unit 100. The data bus 125 is preferably capable of high bandwidth signal communication, and can be implemented in the form of an optical fiber or copper wire. The databus 125 carries information such as, for example, video and left and right audio outputs.

A transmit circuit may be disposed at the distal end of the databus 125, and a receive circuit disposed proximal to the display, to process the audio/video signals for proper transmission or reception of the signals and to facilitate play of the audio/video program at the display.

In an embodiment wherein optical fiber is used as the databus 125, the transmit and receive circuits perform an optical communication protocol, including electrical to optical conversions, to effect signal communication. An example of an optical communication protocol is the Media Oriented Systems Transport (MOST) protocol.

An optical communication protocol, such as MOST, enables efficient transport of streaming multimedia information. Devices can communicate with each other using a high-speed connection over, for example, plastic optical fiber (POF). For example, audio and video programming can be sent around a network for simultaneous playback at several locations in a vehicle. Dynamic equalization and active noise cancellation on all audio signals flowing around the vehicle is possible because digital data is available to all devices on a network. The optical fiber medium, such as, for example, POF, provides low infrastructure costs while making data impervious to electromagnetic disturbances.

An optical protocol, such as the MOST protocol, defines software interfaces to enable applications running on different devices to communicate and exchange information, and defines a transport mechanism that sets up a link for streaming data between devices. The protocol also defines the hardware interface needed to communicate over optical fiber.

In an embodiment where copper wire is used as the databus 125, the transmit and receive circuits perform the necessary multiplexing and data conversion known to one of ordinary skill in the art to effect communication of the programs.

As shown in FIG. 2, the displays 130 are connected to the databus 125 by extension databus lines 140, and are positioned remote from the unit 100, such as in the headrest 10. The remotely positioned display (s) may also be positioned in another part of the vehicle (e.g., overhead, in a center console). In the embodiment shown in FIG. 2 the unit 100 may be positioned in any convenient location in the vehicle, such as overhead, under a seat, in a center console, in a dashboard, in a trunk, etc.

The unit may also include additional media sources (not shown) connected to the databus 125 for feeding programming to the displays. For example, an additional media source may be a DVD player, a CD-ROM player, a video game player, a videocassette player, a television tuner, a radio tuner, an MP3 player, a digital video recorder (DVR), and/or a device for playing media supplied from a portable storage device (e.g., a portable hard drive, memory cards, flash memory sticks, key drives, thumb drives).

Audio signals received by the unit 100 may be sent to displays 130, to a vehicle sound system and to a wireless transmitter (s) 118 via the databus 125. Wireless transmitters 118, using, for example, radio frequency (RF), infrared (IR), BLUETOOTH, or 802.11 techniques, can transmit audio to, for example, receivers connected to a vehicle radio, wireless headphones, or a display having a speaker (s).

In addition to the databus extension lines 140, wires for ground and power 141 (connected to, for example, a vehicle power supply) are connected from the displays 130 to the unit 100. Further, as an alternative to a single databus carrying audio and video, multiple buses, such as a video and an audio bus, may be used.

The databus extension line 140 (e.g., optical fiber or copper wire) is passed through a headrest support 15 routing the databus extension line 140 from the headrest to elsewhere in the vehicle. Upon routing to, for example, the bottom of a seat, the line 140 can be connected to the unit 100. Connection to the unit 100 may be supplied by any appropriate connectors capable of carrying high bandwidth, such as, for example, via a universal serial bus (USB) type connection 173.

Referring to FIG. 2, displays 130 in multiple headrests of a vehicle (e.g., in multiple rows of seating) can be linked via lines 140 connected to the unit 100. Like the databus 125, the extension lines 140 can carry multiple audio and video signals, and use, for example, optical or copper wire protocols capable of carrying high bandwidth.

Depending on selections made by each user on each display 130, the same or different programs can be simultaneously viewed on each of the displays 130.

In an embodiment of the present invention, a centralized power relay 174 located in the unit 100 supplies power to the unit 100 and each of the displays 130 via respective power lines 141 connected to the power relay 174. The power relay 174 is connected to a main power supply 176, such as a vehicle power source.

Connections to the relay 174 and to a power supply of a vehicle and ground may be supplied via connectors/adaptors known to those of skill in the art. The power and ground wires can be run through the same headrest post 15 as or a different headrest post 15A from the lines 140.

The multimedia content available via the receiver and distribution unit 100 includes, for example, video programs, such as movies, television programs, newscasts, and webcasts, audio programs, and navigation information. In addition, a user can access other data or mediums currently available via cellular networks, such as, for example, web/Internet services, including e-mail and browsing, telephone service, and text services, such as news. Delivery of programming can be in the form of real-time streaming media or delayed via a background delivery service, wherein data is downloaded and stored for later viewing.

In an embodiment of the present invention, the receiver and distribution unit 100 can be permanently mounted and wired to displays in a vehicle. Alternatively, the receiver and distribution unit 100 can be a portable unit that can be moved between vehicles. The portable unit, for example, mounts and electrically connects to a docking station in a vehicle, the docking station being appropriately wired to displays and other components, such as speakers and a power source of the vehicle. A portable unit may be a stand-alone unit, including a display, which mounts to a docking station in a vehicle, for example, located overhead in a vehicle. Alternatively, the docking station may be located, for example, in a seat, in a dashboard or in a center console of a vehicle. A stand-alone unit can include a battery attachment so as to operate outside of the vehicle.

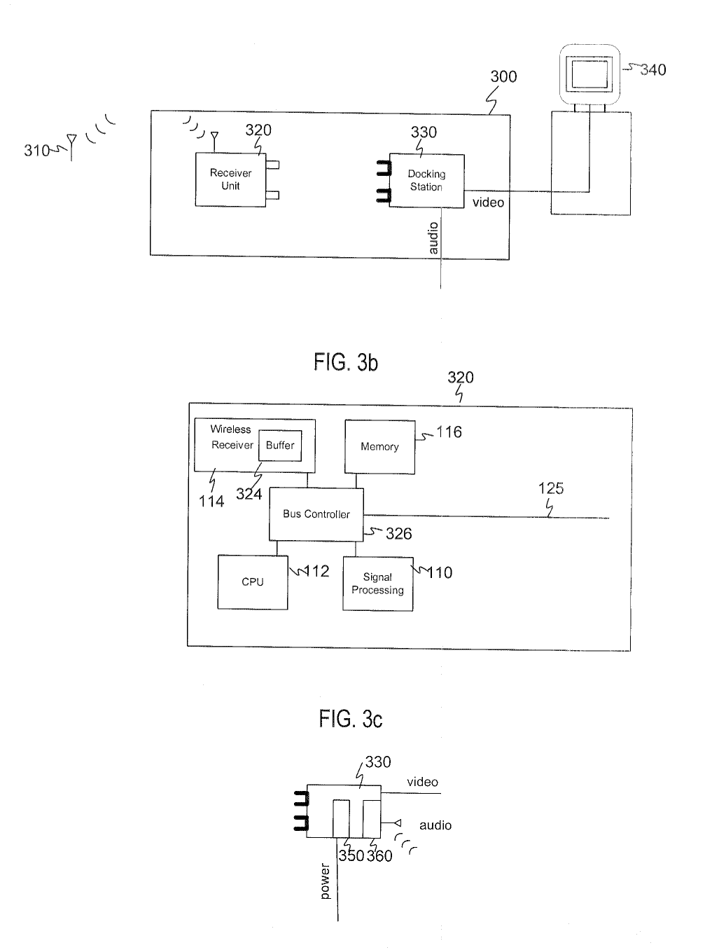

FIG. 3a, 3b, and 3c illustrate a receiver and distribution unit 300, according to an exemplary embodiment of the present invention. Referring to FIG. 3a, the unit 300 includes a receiver unit 320 and a docking station 330. The receiver unit 320 receives wireless media signals from an external source 310, such as a cellular network. FIG. 3b illustrates an embodiment of the receiver unit 320 which has the same general structure and performs the same receiving and decoding functions as the unit 100 illustrated in FIG. 1, and differs in that it does not include a display. The wireless receiver 114 of the receiver unit 320 additionally includes a buffer 324 for temporarily storing raw unprocessed signals received via the external source 310. The buffer 324 can be used to prevent loss of data which may occur if the signal processing of a current media signal has not completed before a new media signal is received by the wireless receiver 114. The wireless receiver 114, the memory 116, the CPU 112, and the signal processing 110 units are first attached to a bus controller 326, which manages the usage of the data bus 125 by the respective units, thereby preventing data collisions. The receiver unit 320 removably docks to the docking station 330. Although the receiving unit 320 and docking station 330 are illustrated as having respectively, 2 male and 2 female connectors, this is merely to illustrate docking. The receiving unit 320 may be connected to the docking station 330 in a variety of methods known to those skilled in the art. Once the receiving unit 320 processes the incoming media signals, it passes the processed media signals to the docking station 330 for distribution of video signals to one or more displays 340 in the vehicle and audio signals to one or more sound systems in the vehicle. Although FIG. 3a illustrates one display, the present invention is not limited thereto, as any number of displays can be supported. The docking station 330 may be wired directly to a sound system of the vehicle.

FIG. 3c illustrates an embodiment of the docking station which may include a centralized power relay 350 and/or a transmitter 360. When the docking station 330 includes the centralized power relay 350, it may provide power to the receiver unit 320, and the one or more displays 340. When the docking station includes a transmitter, it may wirelessly transmit the audio signals for reception by a wireless sound system in the vehicle, such as to wireless headphones. The transmitter may use various methods of transmission, such as, for example, radio frequency (RF), infrared (IR), BLUETOOTH, or 802.11

It should be noted that the units attached to the data bus 125 in FIG. 1 and FIG. 3b are shown in this way for ease of illustration, and there may be intervening circuitry as envisioned by those skilled in the art.

Although exemplary embodiments of the present invention have been described hereinabove, it should be understood that the present invention is not limited to these embodiments, but may be modified by those skilled in the art without departing from the spirit and scope of the present invention, as defined by the appended claims.

What is claimed is:

1. A receiver and distribution unit in a vehicle, comprising:
a wireless receiver unit receiving a first signal wirelessly from a cellular network; and
a signal processor decoding the first signal into a second signal for output to a sound system and a display.

2. The receiver and distribution unit according to claim 1, wherein the second signal includes video signals for output to the display and audio signals for output to the sound system.

3. The receiver and distribution unit of claim 1, wherein the display is mounted in a headrest of a seat in the vehicle.

4. The receiver and distribution unit of claim 1, wherein the display is a liquid crystal display (LCD).

5. The receiver and distribution unit according to claim 1, further comprising:
a common data bus; and
a bus controller for controlling access to the common. data bus,
wherein the wireless receiver and the signal processor are connected to the common data bus via the bus controller.

6. The receiver and distribution unit according to claim 5, wherein the data bus comprises optical fiber.

7. The receiver and distribution unit according to claim 5, wherein the data bus comprises copper wire.

8. The receiver and distribution unit according to claim 1, further comprising:
a memory for storing the second signal.

9. The receiver and distribution unit according to claim 6, wherein the memory includes a memory card that fits into a PMCIA slot.

10. The receiver and distribution unit according to claim 6, further comprising:
a CPU for controlling the receiver and distribution unit.

11. The receiver and distribution unit according to claim 1, further comprising:
a buffer for storing a subsequently received signal until the signal processor has completed processing the first signal.

12. The receiver and distribution unit according to claim 1, further comprising:
a centralized power relay for delivering power to the display.

13. The receiver and distribution unit according claim 2, further comprising:
a wireless transmitter for broadcasting the audio signals to a wireless sound system.

14. The receiver and distribution system according to claim 13, wherein the transmitter transmits the audio signals using infrared (IR).

15. The receiver and distribution unit according to claim 1, wherein the signal processor performs error correction on the first signal.

16. A wireless media system for a vehicle, comprising:
a receiver unit for receiving a first media signal wirelessly from a cellular network;
a speaker;
a display; and
a signal processor for decoding the first media signal output by the wireless receiver into audio and video signals,
wherein the video signals are output to the display and the audio signals are output to the speaker;

17. The wireless media system according to claim 16, further comprising:
a common data bus; and
a bus controller for controlling access to the common data bus,
wherein the receiver unit and the signal processor are connected to the common data bus via the bus controller.

18. The wireless media system according to claim 16, wherein the receiver unit includes a buffering unit to buffer to subsequently received signal until the signal processor has completed processing of the first media signal.

19. The wireless media system according to claim 17, wherein the common data bus comprises optical fiber.

20. The wireless media system according to claim 17, wherein the common data bus comprises copper wire.

21. A receiver and distribution unit for a vehicle, comprising:
a receiver unit which wirelessly receives media signals, and decodes the media signals to generate audio signals and video signals; and
a docking station which transmits the audio signals to a sound system in the vehicle and the video signals to one or more displays in the vehicle,
wherein the docking station is mounted in the vehicle and the receiver unit is removably connected to the docking station.

22. The receiver and distribution unit according to claim 21, wherein the docking station includes a centralized power relay for providing power to the one or more displays.

23. The receiver and distribution unit according to claim 22, wherein the receiver unit receives power from the docking station.

24. The receiver and distribution unit according to claim 21, wherein each of the one or more displays are mounted in a headrest of the vehicle.

25. The receiver and distribution unit according to claim 21, wherein the docking station includes a transmitter for wirelessly broadcasting the audio signals to a wireless sound system.

26. The receiver and distribution unit according to claim 21, further comprising:
a memory for storing the audio and video signals.
